(19) United States
(12) Patent Application Publication
(10) Pub. No.: US 2025/0324945 A1
(43) Pub. Date: Oct. 23, 2025

(54) COMBINED ELECTRONIC FENCE AREA

(71) Applicant: DT SYSTEMS, INC., Dallas, TX (US)

(72) Inventor: Bryant Y. KIM, Dallas, TX (US)

(21) Appl. No.: 18/639,723

(22) Filed: Apr. 18, 2024

(51) Int. Cl. A01K 15/02; A01K 27/00

(52) U.S. Cl. CPC A01K 15/023; A01K 27/001

(57) ABSTRACT

An apparatus, system and method for defining an electronic fence system area electronically to match a desired electronic fence system area is disclosed. An electronic fence system for defining any one of a fence area or a combined fence area in relation to a dog's location includes a controller that further includes a processor, a display and a memory with computer instructions that, when executed by the processor, cause the controller to receive location information from a dog collar, determine whether and how to stimulate the dog based on its position in relation to one of a fence area or a combined fence area. The controller is configured to transmit any one of the fence area or the combined fence area parameters to the dog collar as well as stimulation commands. The fence area or combined fence area may be created either on a controller or a user terminal.

### FIELD OF THE INVENTION

The present invention is related to dog training systems and, more particularly, to electronic fence systems for electronically containing a dog within a defined area.

### BACKGROUND OF THE INVENTION

Electronic fence systems for dogs are known. In essence, electronic fence systems define either a circular area based on a geographic location or an area defined by physical waypoints.

One problem with circular fence areas is that it is sometimes desirable to define an electronic fence area with a different shape without having to walk the desired fence area entering the physical waypoints. For example, it may be desirable to define an electronic fence area that corresponds to a property line. A known system that allows for such a customized electronic fence system is one in which a user may walk the desired electronic fence system designating waypoints to define the fence boundary. Such an approach for defining an electronic fence area, however, may be time consuming and less than optimal. In situations such as a hunting trip, it would be an inconvenience to be required to physically map out the desired electronic fence system area.

What is needed, therefore, is an electronic fence system which allows a user to easily define the electronic fence system area either on a controller or a user terminal in communication with the controller.

### SUMMARY OF THE INVENTION

The present disclosure is directed to an apparatus, system, and method for defining an electronic fence system area electronically to match a desired electronic fence system area. According to one aspect of the present disclosure, an electronic fence system for defining any one of a fence area or a combined fence area in relation to a dog's location includes a controller that further includes a processor, a display, and a memory with computer instructions that, when executed by the processor, cause the controller to receive location information from a dog collar, determine whether and how to stimulate the dog based on its position in relation to one of a fence area or a combined fence area.

According to another aspect of the present disclosure, the controller is configured to transmit any one of the fence area or the combined fence area parameters to the dog collar as well as stimulation commands.

According to another aspect of the present disclosure, the dog collar includes a Global Positioning System (GPS) receiver for receiving signals from GPS satellites to produce location information identifying a dog's location. The dog collar further includes a transceiver for communicating with a controller to transmit the GPS coordinates to the controller and for receiving the fence parameters from the controller. The dog controller further includes a stimulation unit that includes at least one of a shock circuit for generating a shock, a vibration unit for generating a vibration, and a speaker system for generating one of a sound or a recorded voice.

The controller includes at least one transceiver for communicating with the dog collar and with a user terminal. The memory includes instructions, which when executed by at least one processor (hereinafter “a processor or the processor”), cause the controller to receive the location information from the dog collar and to compare the location information to a defined electronic fence area defined within the memory. The controller is further configured to determine whether to stimulate the dog by commanding the stimulation unit to stimulate the dog based on the location information in relation to the electronic fence area defined within the memory.

The controller further includes a display disposed on the control unit configured to receive display information generated by the processor to display any one of the fence area or the combined fence area and the dog's location. According to one or more aspects of the present disclosure, the controller is configured to communicate with a user terminal to exchange any one of the fence area or the combined fence area and the dog collar's location, and stimulation information. The stimulation information can include specifications for how and when to stimulate the dog based on the dog collar location in relation to the fence area or the combined fence area.

According to another aspect of the present disclosure, an electronic fence system for defining any one of a fence area or a combined fence area in relation to a dog's location includes a user terminal and a controller. The controller includes a processor, a display, a transceiver, and a memory that further includes computer instructions that, when executed by the processor, cause the controller to receive location information from a dog collar, transmit the location information to the user terminal, receive from the user terminal and store any one of a fence area or a combined fence area. The computer instructions also, when executed by the processor, cause the controller to transmit any one of the fence area or the combined fence area to the dog collar and to determine whether to stimulate the dog either by commanding the stimulation unit to stimulate the dog based on the location information in relation to the electronic fence area or combined fence area defined within the memory.

According to another aspect of the disclosure, a method for defining any one of a fence area or a combined fence area in relation to a dog's location includes the steps of receiving location information from a dog collar and defining a fence area having a first center point bounded by any one of a circular shape, a rectangular shape or a triangular shape or other geometric shape. The method also includes defining a first supplemental fence area having a second center point bounded by any one of a second circular shape, a second rectangular shape or a second triangular shape and by creating a combined fence area by combining the initially created fence area with all supplemental fence areas.

In one embodiment, the method includes adding selectable extension points along the perimeter of the combined fence area as displayed on a display of either the controller or user terminal. The selectable points allow the fence area or combined fence area to be adjusted by being moved on the display. More specifically, the method includes adjusting the combined fence area based on the selection and movement of at least one selectable extension point to corresponding movement of the selectable extension points on a controller display or a user terminal display. Thus, the method may be performed either by the controller or by the user terminal.

### BRIEF DESCRIPTION OF THE DRAWINGS

FIG. 1 is a diagram of an electronic fence system according to one embodiment of the disclosure.

FIG. 2 is a functional block diagram of a controller according to one embodiment of the present disclosure.

FIG. 3 is a functional block diagram of a user terminal according to one embodiment of the present disclosure.

FIG. 4 is a functional block diagram illustrating one embodiment of a dog collar according to the present disclosure for training and containing a dog within a fence area or combined fence area.

FIG. 5 is a diagram of an electronic fence created according to one embodiment of the disclosure.

FIG. 6 is a flow chart that illustrates a method according to the described embodiment of the disclosure for creating a desired fence area.

FIGS. 7a-7d are a series of diagrams that illustrate creating and adjusting a fence area according to one embodiment of the disclosure.

FIGS. 8a-8b are a pair of diagrams that illustrate creating and adjusting a fence area according to one embodiment of the disclosure.

### DETAILED DESCRIPTION

Hereinafter, embodiments of an electronic fence system include electronic fence systems that may be generated either via a controller or a user terminal according to the present disclosure and will be described with reference to the accompanying drawings. Generally, the various aspects are directed to creating, via the controller or the user terminal, a fence area or a combined fence area having selectable and adjustable sizes and shapes and then the subsequent use of the fence area or combined fence area to contain a dog using a dog collar configured to stimulate the dog either via sound, voice (recording), vibration, or shock. Additionally, not only may a user create an electronic fence area, but the user may also define adjusted fence areas, each of which having an assigned stimulation type. A combined fence area is a fence area that comprises prior selected, sized, and shaped fence areas that are combined into one fence area. In one embodiment, artificial intelligence (AI) software is executed by the controller or the user terminal to create the combined fence area in a manner that reduces user interaction to create the combined fence area.

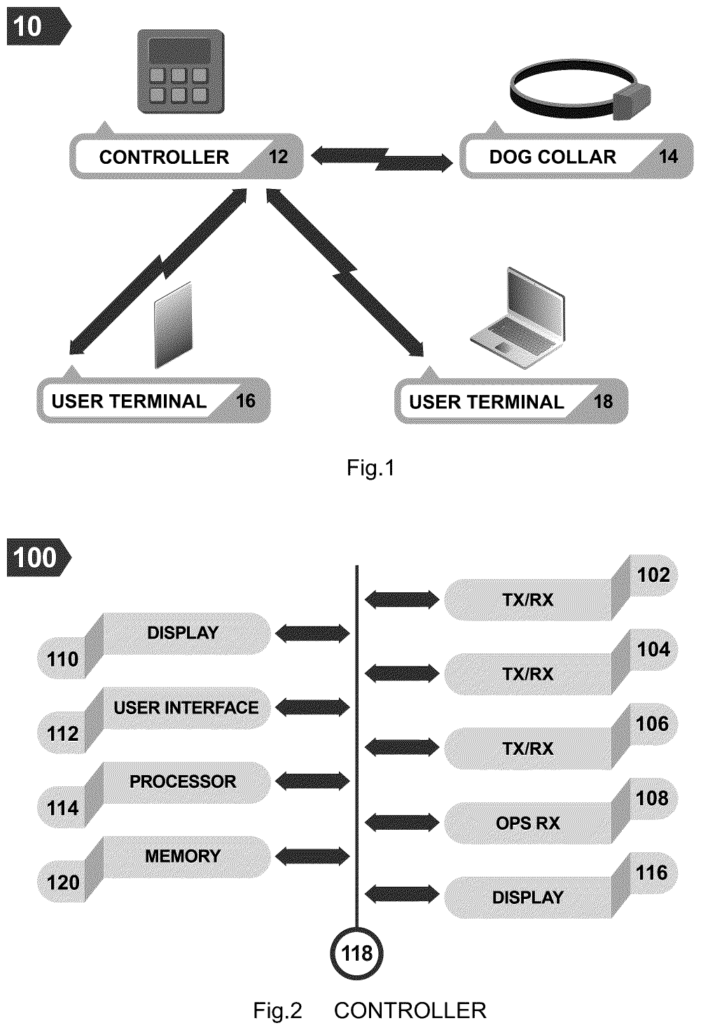

FIG. 1 is a diagram of an electronic fence system according to one embodiment of the disclosure. As may be seen, an electronic fence system 10 includes a controller 100 that wirelessly communicates with a dog collar 200 and a user terminal 150a and/or a user terminal 18. Here, user terminal 150a comprises a mobile phone while user terminal 150b comprises any one of a computer terminal, laptop computer, or computer pad (e.g., iPad®).

An electronic fence system 10 for defining any one of a fence area or a combined fence area in relation to a dog's location, typically includes a controller 100 and a dog collar 200 wherein one or more of the dog collar 200, the controller 100, or the user terminals 150a and/or 150b stores the parameters of an electronic fence system 10 which is used to stimulate the dog when the dog approaches or crosses a boundary (the fence area). In one embodiment, the electronic fence system 10 further includes a user terminal 150a or 150b that may be used to generate the electronic fence as described herein in addition to providing a more friendly user interface to enable the user to select and specify other aspects of operation of the electronic fence system 10. For example, the user terminal 150a or 150b may be configured to provide options for user selection such as stimulation type and stimulation intensity in relation to one or more fence areas (or combined fence areas as well as adjusted fence areas). The user terminal 150a or 150b therefore includes the computer instructions for execution by a processor to facilitate such operation as well as to transmit the various parameters to the controller.

Specifically, controller 100 communicates with dog collar 200 and user terminal 150a or 150b via any known public or non-public communication protocol include cellular protocols, WIFI® communication protocols or short distance communication protocols such as BLUETOOTH®. One aspect of the electronic fence system is that controller 100 is configured to receive location information from dog collar 200 and, based on the location information, determine a designation point for generating an electronic fence and, subsequently, whether and how to stimulate the dog based on its position in relation to one of a fence area or a combined fence area. A defined fence area may comprise a specified shape in relation to a designated point or in relation to a dog's location. The designation point may be based on a collar location at a time that a designate option is selected on the controller or alternatively, at a location of the controller when the designate button is selected. The coordinates of the designation point are then used to form the electronic fence system boundaries.

For example, a fence area may comprise a circle with a specified radius, a square, or a triangle in relation to the dog's position or the designated point. Other geometric shapes including rectangles, ovals, ellipses, pentagons, etc. may be defined for user selection either on the controller or the user terminal. A combined fence area may comprise a number of defined fence areas that are selected and combined to create the combined fence area.

According to another aspect of the described embodiments of the disclosure, the controller 100 is configured to transmit any one of the fence area or a combined fence area parameters to the dog collar 200 to enable the dog collar 200 to determine when a stimulation should be applied to the dog. The controller is further configured to transmit stimulation parameters (user selected stimulation options) to the dog collar 200 for activation in relation to the fence area or combined fence area. The dog collar 200 includes a GPS receiver for receiving signals from GPS satellites to determine location information identifying a dog's location to enable the dog collar 200 to determine whether to stimulate the dog in relation to the fence or combined fence area parameters.

The dog collar 200 includes transceiver circuitry and is further configured to communicate with a controller 100 to produce or transmit the dog's location (the location information of the dog collar 200) to the controller 100 and to receive electronic fence system including combined fence system parameters. In one embodiment, the dog collar 200 is further configured to determine whether to stimulate the dog based on the dog's location in relation to the fence area or the combined fence area based on the received fence parameters from the controller.

The electronic fence system user terminal 150a or 150b includes a processor and a memory with computer instructions which, when executed by the processor of the user terminal configures the user terminal 150a or 150b to create or adjust either a fence area or a combined fence area based on an identified location. This identified location may be done graphically or by designation when the user terminal or controller is disposed and the identified location. The same is therefore true for each supplemental fence area that is created in relation to the initial fence area. Alternatively, the identified location may be the location of the dog collar 200 at a time that the location is selected or designated. Further, each shape that is created in relation to the identified location for defining a fence or supplemental fence may be characterized by a specified distance (e.g. radius or distance to a corner or closest side of the selected shape).

The computer instructions define logic to cause the processer of user terminal 150a or 150b and/or controller 100 to define selectable extension points along the perimeter of the fence area or combined fence area to enable the user, via the user interface of the user terminal, to select one or more selectable extension points to adjust a shape of the fence area or the combined fence area (or the supplemental fence areas before the combined fence area is created). Thus, the computer instructions define logic to cause the processor to adjust the combined fence area based on the selection and movement of at least one selectable extension point to correspond movement of the selectable extension points on the controller display or the user terminal display.

The above method and associated instructions are not limited to just one supplemental fence area. Thus, the memory includes computer instructions that define logic to cause the processor to identify a second or more supplemental fence areas having a third (or more) center points bounded by anyone of a third circular shape, a third rectangular shape or a third triangular shape.

Once the fence or combined fence area is created (collectively “fence area”), either by the controller 100 or the user terminal 150a-150b, the fence area may be used to contain the dog. Thus, the memory of the controller 100 includes computer instructions that define logic to cause the processor to determine that the dog collar 200 containing the stimulation unit has moved outside the fence area or is crossing the fence area and to determine to stimulate the animal with one of a command, a sound, a vibration, or a shock. In this embodiment, the controller transmits a control command to the collar to prompt the collar to generate at least one of the command, the sound, the vibration, or the shock. In an alternative embodiment, the controller 100 transmits the fence area to the collar 200 to enable the dog collar 200 to determine when and how to stimulate the dog in relation to the fence area and received GPS coordinates.

In one embodiment of the electronic fence system 10, the dog collar 200 further includes a beeper communicatively coupled to the stimulation unit for generating a loud sound when a condition is satisfied. For example, the loud sound may be generated when the dog collar 200 is approaching the fence area. In one embodiment, an adjusted area may be defined that is a specified number of feet to the interior of the fence area that has substantially the same shape as the fence area but in a smaller size (all internal to the fence area). As such, the computer instructions enable one of the collar 200, the control unit or the user terminal 150a, 150b to specify the parameters of the internal adjusted area. If the parameters of the internal adjusted area are defined either by the user terminal 150a, 150b or the controller 100, the parameter is transmitted to the dog collar 200 for the embodiment in which the dog collar 200 determines when to stimulate the dog by activating the beeper when the dog collar 200 crosses the adjusted fence area. In another embodiment, the loud sound may be generated once the dog collar 200 has passed outside of the fence area, which can facilitate locating the dog in the event that GPS tracking is unable to provide precise location information, or in the absence of a GPS receiver altogether.

In an alternative embodiment, instead of producing a loud sound or beep, a speaker is provided to produce a recorded command (e.g., “STOP”) when the dog collar 200 approaches or crosses the adjusted area. For this embodiment, the user terminal 150a, 150b includes computer instructions that, when executed by a processor, uses the display to prompt a user to record a command and the microphone and circuitry to record and store the command in memory and subsequently to transmit the stored command to the controller 100 which, in turn, transmits the command to the dog collar 200 for storing and playback. Thus, the controller 100 includes computer instructions for receiving and forward the command to the dog collar 200. The dog collar 200 includes instructions for receiving the command, storing the command, and playing the command upon occurrence of a specified condition (e.g., crossing one of the fence areas).

Specific details of the hardware and software that implement the described methods via computer instructions will be shown in greater detail in relation to the figures that follow. Further, it should be understood that the computer instructions that are executed by one or more processors enable the controller 100 as well as the user terminal(s) 150a, 150b to interpret user selections on a user interface. The user interface includes a display to display options and instructions for a user, soft buttons that may be selected either via a touch screen or a mouse pointer or physical buttons and switches that may be configured to indicate a user activation or selection.

FIG. 2 is a functional block diagram of a controller 100 according to one embodiment of the present disclosure. More specifically, a controller 100 incudes a transceiver 102, a transceiver 104, a transceiver 106, a GPS receiver 108, a display 110, a user interface 112, a processor 114, a memory 116 and a bus 118. Each of these circuits or devices 104-116 of controller 100 are configured to communicate over bus 118. Each of these device 104-118 may be so configured by any combination of hardware using circuit designs as known by those of skill in the art as well as by software that is executed by one or more processors or by any combination of hardware and software. Additionally, controller 100 includes memory 120 that is coupled to processor 114 to provide instructions for execution by processor 114.

Thus, the instructions, when executed by processor 114, cause controller 100 to generate images for display on display 110, to record sounds and commands received via user interface 112, which may include a microphone, and to determine that a user is requesting a specified operation. The instructions further enable the controller 100 to communicate with other devices. For example, transceivers 102, 104 or 106 may be transceivers configured to communicate by BLUETOOTH, WIFI, or cellular and other wireless communication protocols. Further, while only three transceivers are shown here in FIG. 2, the controller 100 may further include a third or a fourth transceiver in alternative embodiments. The computer instructions also cause controller 100 to communicate with GPS receiver 108 to receive GPS coordinates of its own location.

The computer instructions further enable the controller 100 to receive location information from a dog collar 200 and to determine whether a response is required in one embodiment of the present disclosure. Additionally, the instructions enable the controller 100 to transmit the location information to the user terminal 150a, 150b, to receive from the user terminal and store any one of a fence area or a combined fence area, to transmit any one of the fence area or the combined fence area to the dog collar 200 and to determine whether to stimulate the dog either by commanding the stimulation unit to stimulate the dog based on the location information in relation to the electronic fence area or combined fence area defined within the memory.

With brief reference to FIG. 4, the dog collar 200 further includes a stimulation unit 216 which includes at least one of a shock circuit for generating a shock, a vibration unit for generating a vibration, and a speaker system for generating one of a sound or a recorded voice.

Returning back to FIG. 2, the memory 120 further includes instructions, which when executed by the processor 114, cause the controller 100 to receive the location information from the dog collar 200, compare the location information to a defined electronic fence area (or combined electronic fence area) that is defined within the memory 120. The controller 100 is operable, based on the computer instructions executed by the processor 114, to determine whether to stimulate the dog by commanding the dog collar 200 to stimulate the dog based on the location information in relation to the electronic fence area defined within the memory 120. Alternatively, the controller 100 sends the fence parameters to the dog collar 200 to enable the dog collar 200 to determine when and how to stimulate the dog.

In one embodiment of the present disclosure, the controller 100 includes a display 116 disposed on the control unit configured to receive display information generated by the processor 114 to display any one of the fence area or the combined fence area and the location of the dog collar 200. The controller 100 is further configured to communicate with a user terminal 150a, 150b to exchange any one of the fence area or the combined fence area and the dog's location via the dog collar 200, and stimulation information.

In one embodiment, the processor 114 of the controller 100 executes the computer instructions to define and create a fence area or a combined fence area on the display 116 of the controller 100. Additionally, the controller 100 may be configured to transmit the dog location information (e.g., GPS coordinates) to a user terminal 150a, 150b and to subsequently receive fence parameters that define the fence area or the combined fence area. The controller 100 is further configured to store the fence area or the combined fence area in memory 120 as well as to transmit the fence area or combined fence area parameters to the dog collar 200. The computer instructions include instructions that, when executed by one or more processors, e.g., processor 114, enable a device, along with user inputs, generate either the fence area or the combined fence area. In the figures that follow, the methods are described which can be performed either on the controller 100 or the user terminals 150a, 150b, or both the controller 100 and the user terminals 150a, 150b. These instructions may include logic for generating the selectable selection points to enable a user to adjust a shape or size of a selected fence area or combined fence area.

More specifically, the memory (e.g., memory 120) includes computer instructions that define logic to cause the processor 114 to identify a fence area having a first center point bounded by any one of a circular shape, a rectangular shape, a triangular shape or other defined geometric shape. The computer instructions also define logic to cause the processor 114 to identify and generate a first supplemental fence area having a second center point bounded by any one of a second circular shape, a second rectangular shape or a second triangular shape. The first fence area and the supplemental area are both selectable on the display via the user interface to be moved adjacent to each other, in a separated manner or in an overlapping manner. Additionally, the computer instructions define logic to cause the processor 114 to create the combined fence area by combining the fence area with all supplemental fence areas. Regardless of the relative arrangement of the fence area and one or more supplemental fence areas, the computer instructions cause the one or more processors to generate a combined fence area that encompasses the fence area and the one or more supplemental fence areas.

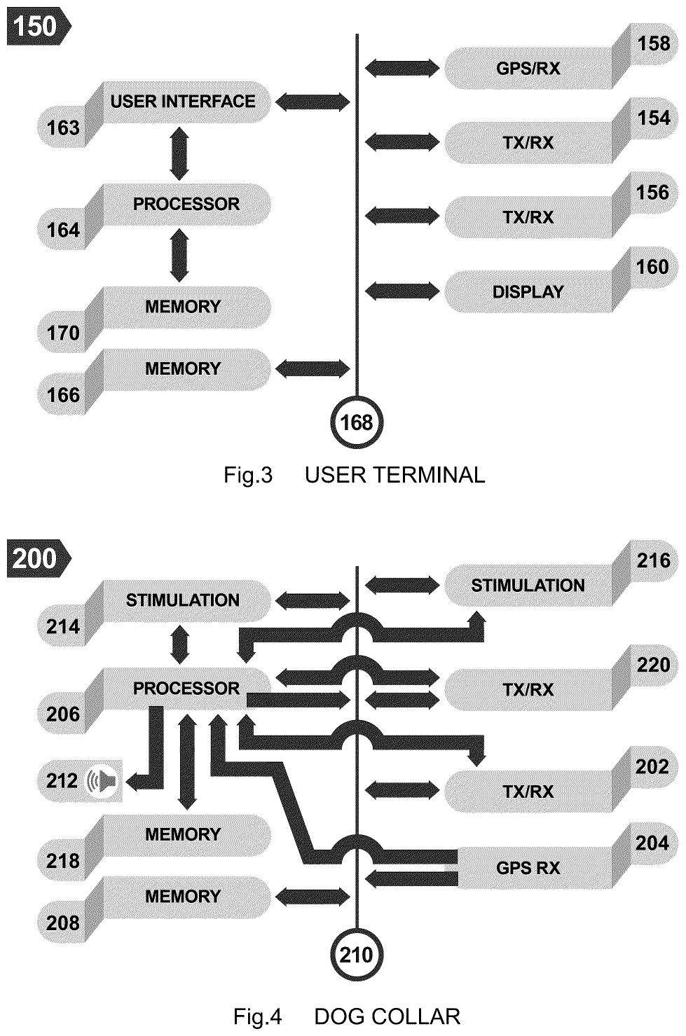

FIG. 3 is a functional block diagram of a user terminal 150 according to one embodiment of the present disclosure. More specifically, a user terminal 150 incudes a transceiver 154, a transceiver 156, a GPS receiver 158, a display 160, a user interface 162, a processor 164, a memory 166 and a bus 168. Each of these circuits or devices 154-166 are configured to communicate over bus 168. Additionally, user terminal 150 includes memory 170 that is coupled to processor 164 to provide instructions for execution by processor 164. It should be noted that either user terminal 150a or 150b of FIG. 1 may be represented by the user terminal 150 of FIG. 3.

Thus, the instructions, when executed by processor 164, cause user terminal 150 to generate images for display on display 160, to record sounds and commands received via user interface 162 (e.g., a microphone or a switch) and to determine that a user is requesting a specified operation. The instructions further enable the user terminal 150 to communicate with other devices. For example, transceivers 154 and 156 may be transceivers configured to communicate by BLUETOOTH, WIFI, or cellular and other wireless communication protocols. Further, while only two transceivers are shown here in FIG. 3, the user terminal 150 may further include a third or a fourth transceiver in alternative embodiments. The computer instructions also cause user terminal 150 to communicate with GPS receiver 158 to receive GPS coordinates of its own location.

The computer instructions further enable the user terminal 150 to wirelessly communicate via transceivers 154 or 156 to receive dog collar 200 location information and/or a coordinate (e.g. a designated location) from a controller, such as controller 100. Additionally, the instructions enable the user terminal to transmit any one of the fence area or the combined fence area to the controller, such as controller 100.

In operation, the computer instructions define logic that cause the user terminal 150 to receive a designation point or dog collar 200 location from the controller 100 and to identify and display an image representing a fence area having a first center point bounded by anyone of a circular shape, a rectangular shape or a triangular shape or other geometric shape. The computer instructions also configure the user terminal 150 to identify and generate a display for a first supplemental fence area having a second center point bounded by any one of a second circular shape, a second rectangular shape or a second triangular shape. According to one aspect, the computer instructions thus define operations of the user terminal 150 to generate an image on the display 160 representing the fence area as well as the supplemental fence area. Additionally, the instructions facilitate the user terminal 150 generating selectable points on the fence area and the supplemental area to allow a user to drag a portion of a displayed fence line to change the size and/or shape of the fence area or the supplemental fence area.

The computer instructions further cause the user terminal 150 to create a combined the fence area by combining the fence area with all supplemental fence areas. Further, as with the fence area and the supplemental fence area, the user terminal 150 is operable to generate selection points for the combined fence area to enable the user to change the size or shape of the combined fence area as well as to move (as with the fence area and supplemental fence area).

It should be noted that multiple supplemental fence areas may be created, selected, adjusted, moved and combined as described before. Thus, the computer instructions enable the user terminal 150 to identify a second supplemental fence area having a third center point bounded by anyone of a third circular shape, a third rectangular shape or a third triangular shape and to combine all supplemental fence areas with the fence area to create a combined fence area.

FIG. 4 is a functional block diagram illustrating one embodiment of a dog collar 200 according to the present disclosure for training and containing a dog within a fence area or combined fence area. The dog collar 200 includes a transceiver 202, a GPS receiver 204, a processor 206, a memory 208, and a bus 210. The dog collar 200 further includes a speaker 212, a stimulation module 214 and a stimulation module 216 and a memory 218 that is directly coupled to processor 206.

As may be seen, processor 206, memory 208, transceiver 202, GPS receiver 204 and stimulation modules 214 and 216 are all coupled to communicate over bus 210. Additionally, stimulation module 214, speaker 212, and memory 218 are also coupled to communicate directly with processor 206. Moreover, as shown in FIG. 4, the various devices may be coupled to communicate with each other via the bus 210 or directly according to design preference. Transceivers 202 and 220, as well as GPS receiver 204, and stimulation units 214 and 216 may, for example, communicate with processor 206 either via bus 210 or directly.

In one embodiment of the present disclosure, memory 218 includes computer instructions for execution by processor 206 to enable the dog collar 200 to operate as described here in this disclosure. Memory 208, which is operable to communicate over bus 210, is configured to store data the dog collar 200 received via transceiver 202, GPS receiver 204, and as generated by processor 206. For example, when the dog collar 200 receives the parameters of a fence or of a combined fence area via transceiver 202, processor 206 processes the received parameters and then produces the parameters for storage in memory 208.

Additionally, processor 206 receives computer instructions from memory 218 to determine when and how to stimulate a dog either for training purposes or to contain the dog within a fence area or combined fence area. For example, the computer instructions may prompt the dog collar 200 to generate a stimulation when a signal is received from a controller 100 to stimulate the dog or when GPS coordinates received from GPS receiver 204 indicate that the dog collar 200 is approaching or crossing an electronic fence or an adjusted fence area.

Based on the computer instructions received from memory 218, the processor 206 may stimulate the dog either by playing a loud sound from speaker 212, generate a vibration from stimulation module 214 or 216, or generate a shock from stimulation module 214 or 216. If, for example, stimulation module 216 contains a vibration unit or motor, processor 206 transmits a control signal over bus 210 (or via direct connection) to stimulation unit 216 to generate a vibration. If the stimulation unit 214 is a shock generator, processor 206 may generate shock commands to stimulation unit 214 either via bus 210 or via the direct connection. Generally, processor 206 executes the computer instructions received from memory 218 to generate defined pulse or shock patterns when stimulating the dog. For example, processor 206 may be configured to generate an increasing shock level that may be represented as a ramp function. Alternatively, processor 206 may generate ever increasing shock pulses separated by periods of no shock. With respect to the speaker 212, processor 206 may either produce a recorded command to speaker 212 which is stored in memory 208 or a recorded sound such as a beep or horn type sound.

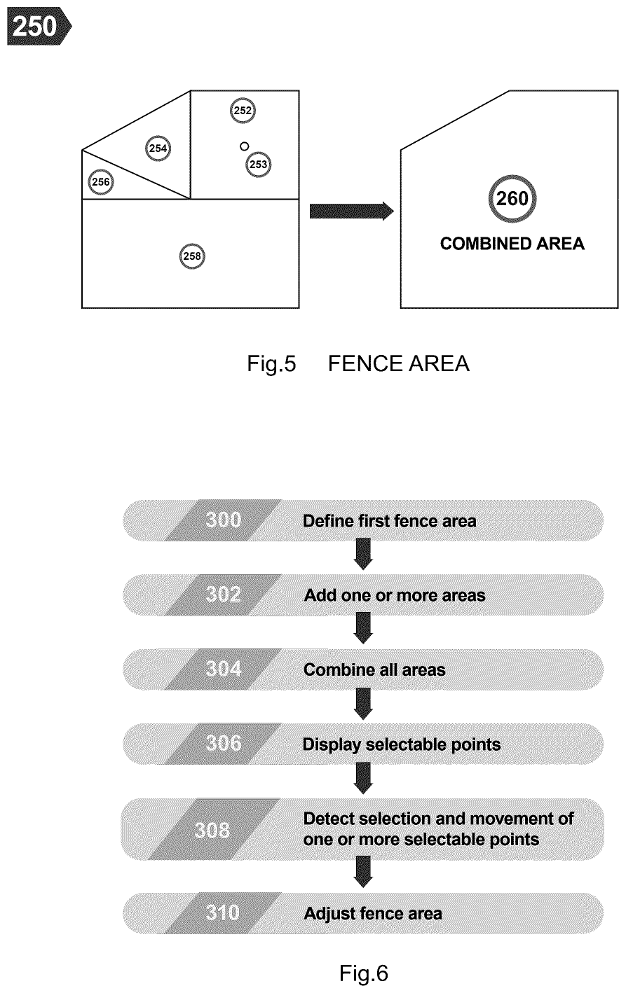

FIG. 5 is a diagram of an electronic fence created according to one embodiment of the disclosure. As may be seen, a desired electronic fence area 250 includes a first fence area 252, a second fence area 254, a third fence area 256 and a fourth fence area 258. Generally, the desired fence area is created by creating the first fence area 252 by selecting a shape of a plurality of shapes for a fence area. In the described embodiment, the selectable shapes include a square, a rectangle, a circle and a triangle or any other defined geometric shape. The selected shape is placed about a designated point or a present location of the dog collar 200. In the example of FIG. 5, the selected shape is a square and the center point of the square is the designated point or dog collar 200 location. The size of the first fence area 252 is one that is selected or specified by the user. More specifically, the controller 100 or the user terminal 150a, 150b provide options on the associated display for the user to select (shape and size parameters) and then based on a designate button being depressed or selected on the controller 100 (or user terminal 150a, 150b) or based upon the dog collar 200 location, a display is generated displaying the electronic fence.

Subsequent to the creation of the first fence area 252, the controller or the user terminal similarly generates subsequent fence areas 254-258. Each of the subsequent fence areas may be adjusted in size or shape and may be moved and rotated as desired to graphically dispose the subsequent fence areas near to, adjacent to or overlapping the first fence area 252. Any known user interface based display method of manipulating objects on a screen may be utilized. Once all of the subsequent fence areas are created and placed into their final graphical location, the controller 100 and/or user terminal 150a, 150b are operable to create the combined fence area which matches the desired fence area 250. As will be explained in greater detail elsewhere, the controller 100 and the user terminal 150a, 150b, depending upon the embodiment, contain the computer instructions that, when executed by the associated processor of the controller 100 or user terminal 150a, 150b, that enable and/or configured the controller 100 or user terminal 150a, 150b to create and define the fence areas 250-258 as described.

FIG. 6 is a flow chart that illustrates a method according to the described embodiment of the disclosure for creating a desired fence area. For example, the method of FIG. 6 may be performed by a controller 100 or a user terminal 150a, 150b to create the desired area 250 which is a combined fence area as described in relation to FIG. 5. The first step of the method is to create the first area 252 (step 300). Creating the first area includes receiving the coordinates of a designated location or a location of the dog collar 200. In the case of a controller 100, the controller 100 receives dog collar location information, and upon selection by the user, uses that location information to be the center point of the first fence area 252. For this embodiment, the method includes receiving user inputs to select the shape of the first fence area 252 and size parameters that are desired (radius or diameter for a circle, side lengths for a triangle, square or rectangle, etc.). Alternatively, the center point may also be generated by placing the controller in the desired center point and identifying that location by receiving GPS coordinates of the controller 100 at the time that the user depresses a designate button.

In the case of the fence being established via a user terminal 150a, 150b, the user terminal 150a, 150b receives location information of the center of the first fence area 252. The location information can be received from the controller 100 or directly from the dog collar 200. The location information may be either a designated location or a location of the dog collar 200. As with the controller 100, the user terminal 150a, 150b receives user inputs regarding the selected shape and sizing parameters of the first fence area 252. The user terminal then generates an image on the user terminal display that corresponds to the first fence area. Subsequently, the controller or user terminal is configured (by executing instructions stored in memory) to add one or more subsequent supplemental fence areas (step 302) and to combine the first fence area and all of the supplemental fence areas to create a combined fence area (step 304).

The method also includes displaying selectable points either along the perimeters of the first and supplemental fence areas or along the combined fence area (step 306). Thereafter, the method includes detecting selection and movement of one or more selectable points to reshape the associated fence area (step 308) (first fence area, supplemental fence area or combined fence area) and drawing the graphical fence area to corresponding the adjusted or moved selection point(s).

With respect to the controller, the method for defining any one of a fence area or a combined fence area in relation to a dog's location includes receiving location information from a dog collar and defining a fence area having a first center point bounded by anyone of a circular shape, a square shape, a rectangular shape or a triangular shape. The method further includes defining a first supplemental fence area having a second center point bounded by any one of a second circular shape, a second square shape second rectangular shape or a second triangular shape. The method also includes creating a combined the fence area by combining the fence area with all supplemental fence areas.

The method further includes displaying selectable extension points along the perimeter of the combined fence area on a display associated with the controller. The method thus includes adjusting the combined fence area based on the selection and movement of at least one selectable extension point to correspond movement of the selectable extension points on a controller display or a user terminal display (step 310).

The step of displaying selectable points and adjusting the fence area may also be performed prior to the first and the supplemental fence areas being combined. As described before, this method may also be by a user terminal with the previously described modifications (e.g., the controller sends the location information to the user terminal).

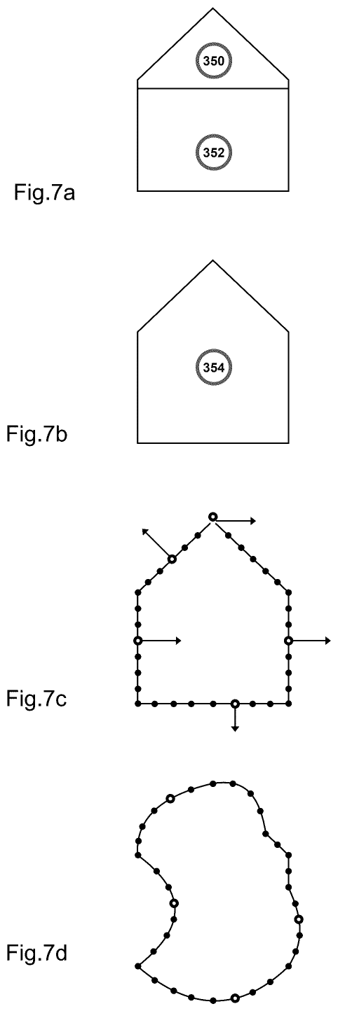

FIGS. 7a-7d are a series of diagrams that illustrate creating and adjusting a fence area according to one embodiment of the disclosure. In general, the computer instructions within either the controller 100 or the user terminals 150a, 150b, or both, facilitate creation of a combined fence area as illustrated in FIGS. 7a-7d.

Initially, a triangular fence area 350 is selected by user input and drawn upon an associated display of either a controller or user terminal. A square fence area 352 is also selected by user input and is drawn adjacent to fence area 350. It should be understood that the square fence area 352 may not initially be displayed adjacent to triangular fence area 350 but that either one of the two areas 350-252 may be moved, rotated, adjusted and sized to result in the two adjacent fence areas as shown in FIG. 7a. Thus, based on user input, one or both of the fence areas 350-352 are moved so that they are adjacent as shown in FIG. 7a.

FIG. 7b then illustrates the fence areas 350-352 being combined to form a combined fence area 354 based upon a user input. FIG. 7c then illustrates a plurality of selection points 356 being shown around the perimeter of fence area 354. Moreover, some of the selection points 356 have arrows to illustrate the direction in which the selection points 356 will be selected and moved based on user input to create a resulting combined fence area 358 as is shown in FIG. 7d. Generally, what FIGS. 7a-7d illustrate is the creation of a combined fence area by combining two or more fence areas and then the subsequent adjustment of the combined fence area by selection and movement of the selection points 356.

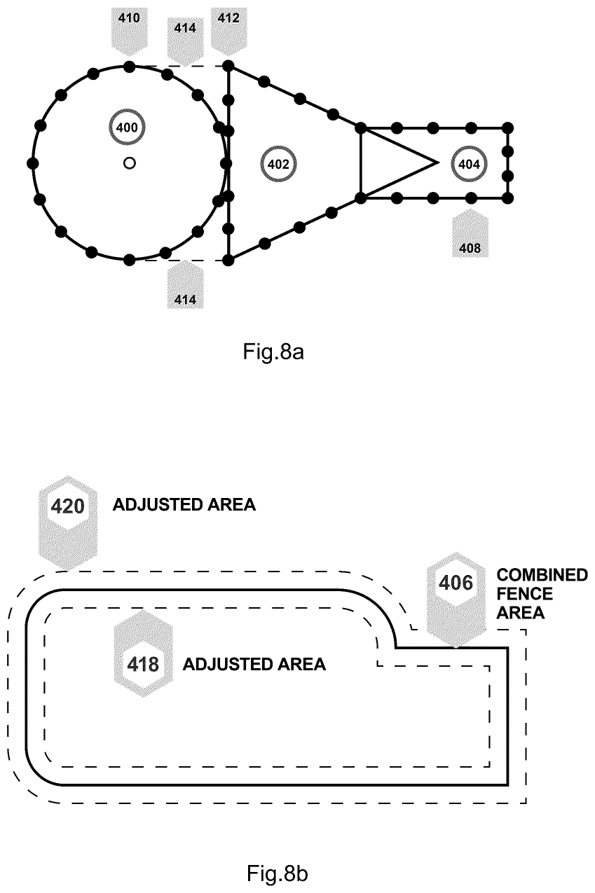

FIGS. 8a-8b are a pair of diagrams that illustrate creating and adjusting a fence area according to one embodiment of the disclosure. In general, the computer instructions within either the controller or the user terminal, or both, facilitate creation of a combined fence area as illustrated in FIGS. 8a-8b.

Initially, a circular fence area 400 is selected by user input and drawn upon an associated display. A triangular fence area 402 is also selected by user input and is drawn adjacent to fence area 400. A third fence area, namely a rectangular fence area also is selected by user input and drawn upon the associated display. As may be seen, fence area 400 and 402 are moved to be disposed adjacent to each other. Rectangular fence area 404, however, is selected and moved to partially overlap triangular fence area 402.

FIG. 8b then illustrates the fence areas 400-404 being combined to form a combined fence area 406 based upon a user input. FIG. 8a also illustrates a plurality of selection points 408 being shown around the perimeter of each of the fence areas 400-404. Going back to FIG. 8b, it may be seen that the combined fence area 406 has also had its shape previously modified by selection and movement of the selection points 408 (as shown in FIG. 8a). It should be understood that the shape of the fence areas 400-404 may be adjusted prior to being combined to form fence area 406 or the perimeter of fence area 406 may be adjusted by selection and movement of selection points 406 (not shown in FIG. 8b).

Generally, what FIGS. 8a-8b illustrate is the creation of a combined fence area by combining two or more fence areas and the adjustment of the combined fence area by selection and movement of the selection points 356. Additionally drawn fence areas may be disposed in any position in relation to each other before the creation of a combined fence area. The creation of the combined fence area (here 406) may be done by drawing a shape that follows the perimeters of the fence areas. In one embodiment, artificial intelligence software may be employed to facilitating the creation of a combined fence area that would more likely be desired than merely tracing the combined perimeters. For example, AI software instructions could determine to draw a fence line from point 410 of area 400 to point 412 of area 402 as shown by fence line 414. As such, a user may be saved a step of selecting a selection point to drag a fence line to 414.

Another aspect illustrated by FIG. 8b is that one embodiment of the present disclosure includes computer instructions or logic to draw one or more adjusted fence areas. In the example of FIG. 8b, an adjusted area 418 and adjusted area 420 are created. Fence area 418 is disposed within combined fence area 406 while adjusted fence area 420 is disposed external to combined fence area 406. In one example embodiment, a user specifies a separation distance from combined fence area 406 for adjusted fence areas 418 and 420. The separation distance may be the same for each or may be specified separately. As noted, the adjusted fence areas 418 and 420 have a substantially similar shape to combined fence area 406. Adjusted fence area 418 is smaller than fence area 406 and is disposed within fence area 406 while adjusted fence area 420 is larger than fence area 406 and encompasses fence area 406.

In operation, when a dog collar 200 crosses from inside adjusted area 418 into a space between adjusted fence area 418 and combined fence area 406, a first type of simulation is generated (e.g., a vibration, sound, recording or shock). When the dog collar 200 crosses the combined fence area 406 into a space between combine fence area 406 and adjusted fence area 420, a second type of stimulation is generated (e.g., a vibration, sound, recording or shock). When the dog collar 200 crosses the adjusted fence area 420, a third type of stimulation is generated (e.g., a vibration, sound, recording or shock). It should be noted the first, second, and third types of stimulation are selectable by the user. Additionally, the intensity level (e.g., vibration level, volume of sound or recording, or shock level) is also selectable. The computer instructions executed by the one or more processors cause the associated device to operate according to the described aspect.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents, and alternatives falling within the spirit and scope of the present invention as defined by the claims.

What is claimed is:

1. An electronic fence system for defining any one of a fence area or a combined fence area in relation to a location of a dog, comprising:
a controller including:
a processor;
a display;
a transceiver for communicating with a dog collar and with a user terminal; and
a memory with computer instructions that, when executed by the processor, cause the controller to:
receive location information from the dog collar;
compare the location information to a defined electronic fence area defined within the memory, wherein the defined electronic fence area comprises one of a fence area or a combined fence area;
determine whether and how to stimulate the dog based on the location of the dog in relation to the defined electronic fence area; and
transmit parameters of the defined electronic fence area to the dog collar;
wherein the display is disposed on the controller configured to receive display information generated by the processor to display the defined electronic fence area and the dog's location; and
wherein the controller is configured to communicate with a user terminal to exchange any one of defined electronic fence area and the location of the dog, and stimulation information.
the dog collar including:
a GPS receiver for receiving signals from GPS satellites to produce location information identifying the location of the dog;
a transceiver for communicating with the controller to transmit GPS coordinates to the controller and for receiving the parameters of the defined electronic fence area from the controller;
a stimulation unit, the stimulation unit including:
a shock circuit for generating a shock;
a vibration unit for generating a vibration; and
a speaker system for generating one of a sound or a recorded voice.

2. The electronic fence system of claim 1 wherein the memory includes computer instructions that define logic to cause the processor to:
identify a fence area having a first center point bounded by anyone of a circular shape, a rectangular shape or a triangular shape, wherein the defined electronic fence area is the fence area.

3. The electronic fence system of claim 2 wherein the memory includes computer instructions that define logic to cause the processor to:
identify a first supplemental fence area having a second center point bounded by any one of a second circular shape, a second rectangular shape or a second triangular shape, wherein the defined electronic fence area includes the first supplemental fence area.

4. The electronic fence system of claim 3 wherein the memory includes computer instructions that define logic to cause the processor to:
create the combined the fence area by combining the fence area with all supplemental fence areas, wherein the defined electronic fence includes the combined fence area.

5. The electronic fence system of claim 4 wherein the memory includes computer instructions define logic to cause the processor to:
define selectable extension points along the perimeter of the combined fence area.

6. The electronic fence system of claim 1 wherein the memory includes computer instructions define logic to cause the processor to:
adjust the combined fence area based on the selection and movement of at least one selectable extension point to correspond movement of the selectable extension points on the controller display or the user terminal display.

7. The electronic fence system of claim 3 wherein the memory includes computer instructions that define logic to cause the processor to:
identify a second supplemental fence area having a third center point bounded by anyone of a third circular shape, a third rectangular shape or a third triangular shape, wherein the defined electronic fence area includes the second supplemental fence area.

8. The electronic fence system of claim 5 wherein the memory includes computer instructions define logic to cause the processor to:
combine the fence area with all supplemental fence areas to create a combined fence area.

9. The electronic fence system of claim 1 wherein the memory includes computer instructions define logic to cause the processor to:
determine that the dog collar unit has moved outside the fence area; and
determine to stimulate the dog with one of a command, a sound, a vibration or a shock; and
transmit a control command to the collar to prompt the collar to generate at least one of the command, the sound, the vibration or the shock.

10. The electronic fence system of claim 1 wherein the dog collar further includes a beeper coupled to communicate with the stimulation unit for generating a loud sound when a condition is satisfied.

11. The electronic fence system of 1 wherein the display is disposed on and a part of the controller and wherein the processor, while executing instructions to create or adjust the defined electronic fence area, generates display signals for generating a corresponding image on the display.

12. The electronic fence system of 1 wherein the user terminal includes processor and memory with instructions which, when executed by the user terminal processor configures the user terminal to create or adjust the defined electronic fence area based on an identified location.

13. The electronic fence system of claim 1 wherein the identified location is a location of one of the dog collar or the controller at a time a user selects a designate option.

14. An electronic fence system for defining any one of a fence area or a combined fence area in relation to a location of a dog, comprising:
a user terminal;
a controller including:
a processor;
a display;
a transceiver;
a memory with computer instructions that, when executed by the processor, cause the controller to:
receive location information from a dog collar;
transmit the location information to the user terminal;
receive from the user terminal and store any one of a fence area or a combined fence area;
transmit any one of the fence area or the combined fence area to the dog collar; and
determine whether to stimulate the dog either by commanding the stimulation unit to stimulate the dog based on the location information in relation to the electronic fence area or combined fence area defined within the memory.

15. The electronic fence system of claim 14 wherein the user terminal comprises a second processor and a second memory that includes computer instructions that define logic to cause the user terminal to:
identify the fence area having a first center point bounded by anyone of a circular shape, a rectangular shape, a triangular shape or any other defined geometric shape.

16. The electronic fence system of claim 15 wherein the second memory includes computer instructions that when executed by the second processor, cause the user terminal to:
identify a first supplemental fence area having a second center point bounded by any one of a second circular shape, a second rectangular shape, a second triangular shape or any other second defined geometric shape.

17. The electronic fence system of claim 16 wherein the second memory includes computer instructions that when executed by the second processor, cause the user terminal to:
create a combined the fence area by combining the fence area with all supplemental fence areas.

18. The electronic fence system of claim 17 wherein the second memory includes computer instructions that when executed by the second processor, cause the user terminal to:
define selectable extension points along the perimeter of either the fence area or the combined fence area.

19. The electronic fence system of claim 17 wherein t the second memory includes computer instructions that when executed by the second processor, cause the user terminal to:
identify a second supplemental fence area having a third center point bounded by anyone of a third circular shape, a third rectangular shape, a third triangular shape or any other third defined geometric shape.

20. The electronic fence system of claim 19 wherein the second memory includes computer instructions that when executed by the second processor, cause the user terminal to:
combine the fence area with all supplemental fence areas to create a combined fence area.

21. The electronic fence system of claim 20 wherein user terminal includes computer instructions that when executed by the second processor cause the user terminal to generate any one of the fence area or the combined fence area.

22. The electronic fence system of claim 20 wherein user terminal includes computer instructions that when executed by the second processor cause the user terminal to identify selection and movement of a selection point and to adjust a shape of the fence area or combined fence area.

23. The electronic fence system of claim 20 wherein user terminal includes computer instructions that when executed by the second processor cause the user terminal to identify selection the fence area and at least one supplemental fence area and to combine the fence area and the at least one supplemental fence area to create the combined fence area.

24. The electronic fence system of claim 15 wherein the second memory includes computer instructions that when executed by the second processor, cause the user terminal to:
adjust the combined fence area based on the selection and movement of at least one selectable extension point to correspond movement of the selectable extension points on the controller display or the user terminal display.

25. A method for defining any one of a fence area or a combined fence area in relation to a location of a dog, the method comprising:
receiving location information from a dog collar; and
defining a fence area having a first center point bounded by any one of a circular shape, a rectangular shape or a triangular shape.

26. The method of claim 25 further including defining a first supplemental fence area having a second center point bounded by any one of a second circular shape, a second rectangular shape or a second triangular shape.

27. The method of claim 25 further including creating the combined fence area by combining the fence area with all supplemental fence areas.

28. The method of claim 27 further including receiving a selection of selectable extension points along the perimeter of the combined fence area.

29. The method of claim 28 further including adjusting the combined fence area based on the selection and movement of at least one selectable extension point to correspond movement of the selectable extension points on a controller display or a user terminal display.

30. The method of claim 29 wherein the method is performed by a controller.

31. The method of claim 30 where the method is performed by a user terminal.
